(19) United States
(12) Patent Application Publication
(10) Pub. No.: US 2006/0193427 A1
(43) Pub. Date: Aug. 31, 2006

(54) Fuel assembly for a pressurized water nuclear reactor

(75) Inventors: Jurgen Stabel, Erlangen (DE); Rudi Reinders, Erlangen (DE); Mingmin Ren, Erlangen (DE)

Correspondence Address: LERNER GREENBERG STEMER LLP, P O BOX 2480, HOLLYWOOD, FL, 33022-2480, US

(73) Assignee: Framatome ANP GmbH

(21) Appl. No.: 11/399,138

(22) Filed: Apr. 6, 2006

Related U.S. Application Data
(63) Continuation of application No. PCT/EP05/01137, filed on Feb. 4, 2005.

(30) Foreign Application Priority Data
Mar. 25, 2004 (DE) 10 2004 014 499.0

(51) Int. Cl. G21C 3/32

(52) U.S. Cl. 376/434

(57) ABSTRACT

A fuel assembly for a pressurized water reactor has a plurality of fuel rods that are guided inside a plurality of axially spaced-apart spacers that are composed of grid webs. Each grid web forms a grid with a multitude of grid cells disposed in rows and columns. The grid webs are provided with flow guides for generating a cooling water current encompassing a transversal flow component that is oriented parallel to the spacer plane. At least one spacer is formed of a multitude of sub-regions, each of which is greater than one grid cell. The flow guides are configured and distributed within the spacer in such a way that in the wake above each sub-region, a transverse flow distribution is created which causes cooling water to be exchanged at least almost exclusively between secondary flow ducts located within the sub-region.

### CROSS-REFERENCE TO RELATED APPLICATION

This is a continuing application, under 35 U.S.C. §120, of copending international application No. PCT/EP2005/001137, filed Feb. 4, 2005, which designated the United States; this application also claims the priority, under 35 U.S.C. §119, of German patent application No. 10 2004 014 499.0, filed Mar. 25, 2004; the prior applications are herewith incorporated by reference in their entirety.

### BACKGROUND OF THE INVENTION

### FIELD OF THE INVENTION

The invention relates to a fuel assembly for a pressurized water reactor, as it is known, for example, from U.S. Pat. No. 6,167,104 and German patent DE 196 35 927 C1.

An exemplary such fuel assembly or fuel element is illustrated in FIG. 13. There, a multiplicity of fuel rods 2 are guided mutually parallel in the rod direction (axially) by a plurality of spacers 4 mutually separated axially, which respectively form a two-dimensional grid with a multiplicity of grid cells 6 that are arranged in columns 8 and rows 10. Besides the fuel rods 2, support tubes which do not contain fuel and are intended to hold and guide control rods (so-called control rod guide tubes 12) are also guided at selected positions through the grid cells 6 of this grid. There may furthermore be support tubes which likewise do not contain fuel and are merely used to increase the stability (instrumentation tubes or structure tubes, there being neither instrumentation tubes nor structure tubes in the fuel assembly represented by way of example).

In order to increase the critical heat flux (CHF), the spacers are provided with flow guiding means which besides a local mixing function, for example by generating a circular flow downstream of the spacer, also have the function of inducing a transverse exchange of the coolant between hotter regions and colder regions of the fuel assembly. Such transverse exchange is used to homogenize the coolant temperature over the entire cross-sectional area of the fuel assembly, and thereby increase the critical heat flux. The transverse exchange may also take place beyond the borders of a fuel assembly, as is known from German published patent application DE 21 22 853 A and U.S. Pat. No. 3,749,640. The prior patent discloses a fuel assembly for a pressurized water reactor, in which such transverse exchange also takes place between neighboring fuel assemblies, in that a circulating flow is generated around an intersection point formed by four neighboring fuel assemblies.

In fuel assemblies having spacers whose grid cells are separated from one another by single-walled grid bars as in the embodiment known from German application DE 21 22 853 A and U.S. Pat. No. 3,749,640, these flow guiding means are formed by guide plates which are arranged on the downstream side around the center of a flow sub-channel, formed by an intersection point of the grid. These guide plates are also referred to as circulator of deflector vanes. There may be up to four such guide plates or vanes at each intersection point.

Such a known fuel assembly is represented in plan view of a spacer 4a in FIG. 14. The spacer 4a is constructed from a multiplicity of perpendicularly intersecting grid bars 20, which pass through one another. The grid bars 20 form approximately square grid cells 6 to hold the fuel rods 2, which are firmly clamped in the grid cells 6 by pins 22 and springs 24. Deflector elements 26, which are circulator vanes bent off laterally in the exemplary embodiment of the figure, are in this case arranged at the grid bars 20 of the spacer 4a. The circulator vanes are arranged on the intersection points so that coolant flowing between the fuel rods 2 through the spacers 4a in the axial direction (parallel to the fuel rods 2), in so-called flow sub-channels 30 respectively lying at the intersection points of the grid bars, is deflected and a (horizontal) velocity component directed perpendicularly to the axial direction is set up. In the exemplary embodiment specifically represented, a circulation D about the mid-axis 28 of the flow sub-channel 30 is imposed on the flow. The rotation due to the circulator vanes leads to better local mixing of the coolant flowing in this flow sub-channel 30, and increases the critical heat flux on the downstream side. Neighboring circular flows have a mutually opposite direction, so that the torques respectively exerted compensate for one another when considered over the entire fuel assembly cross section. An exchange of the coolant takes place between neighboring flow sub-channels 30 owing to the imposed circular flows, although this has only a moderate effect.

An improvement of the transverse transport of the coolant in the fuel assembly is achieved by a spacer 4b as shown in FIG. 15, the fuel rods passing through the grid cells 6 not been represented in this figure and the subsequent figures for the sake of clarity. In each of the flow sub-channels 30 formed by four mutually adjacent grid cells 6, the spacer 4b contains only two deflector elements 26, which deflect the coolant in an opposite direction. In each flow sub-channel 30, a circulating flow is generated in the direction of the arrows 31. They are superimposed to form superordinate transverse flows 32, i.e. ones extending over a plurality of grid cells, in the direction of the diagonal. These so-called diptera (two-winged) therefore have an improved mixing ratio compared with tetraptera (four-winged), as is clearly shown on a reduced scale in FIG. 16. The resulting transverse flows 32 extend virtually over the entire cross section of the fuel assembly.

An alternative spacer design is known, for example, from U.S. Pat. No. 4,726,926 and European published patent application EP 0 237 064 A2. In the spacer disclosed therein, each grid bar is formed by two thin metal strips welded together. Instead of circulator vanes on the upper edge of the grid bar, the metal strips in these spacers are provided with raised profiles which extend into the interior of the grid cell respectively bounded by the metal strip. Oppositely neighboring profiles of the metal strips, which are assembled to form a grid bar, respectively form an approximately tubular flow channel extending in the vertical direction. Each flow channel is inclined relative to the vertical and generates a flow component of the cooling liquid oriented parallel to the bar and directed at an intersection point of the bars. The inclination angles of the flow sub-channels are in this case arranged so as to create a circular flow around the fuel rods respectively passing through the grid cells.

When such a known double-walled spacer is used, only slight fretting damage can be observed on the fuel rod cladding tubes in practical operation.

The flow pattern due to such a known spacer 4c gin the through-flow is represented in FIG. 17 with the aid of the arrows 40. In the flow channels 44 formed by profiles 42, a transverse component of the flow is imposed on the coolant and leads to circulation of the coolant around the fuel rods respectively passing through the grid cells. Since the transverse flows 40 generated by the flow channels 44 neighboring an intersection point of the grid bars oppose each other in pairs, only minor and furthermore at most labile transverse coolant exchange is generated beyond the respective grid cell boundary, i.e. between in the grid cells.

It is has become known from German utility model DE 201 12 336 U1 furthermore to provide such a double-walled spacer with guide vanes in the vicinity of the intersection points, in order to superimpose a flow component transverse to the fuel rod on the coolant flowing through the flow sub-channel. This measure can improve the critical heat flux.

### SUMMARY OF THE INVENTION

It is accordingly an object of the invention to provide a fuel assembly for a pressurized water reactor which overcomes the above-mentioned disadvantages of the heretofore-known devices and methods of this general type and which provides for a fuel assembly that is optimized both in respect of its critical heat flux and in respect of its fretting properties.

With the foregoing and other objects in view there is provided, in accordance with the invention, a fuel assembly for a pressurized water nuclear reactor, comprising:

a multiplicity of fuel rods;

a multiplicity of axially separated spacers holding the fuel rods, the spacers being constructed of mutually intersecting grid bars forming a grid with a multiplicity of grid cells arranged along rows and columns;

the grid bars including flow guiding devices for imposing a transverse flow component, oriented parallel to a spacer plane, on cooling water respectively flowing axially in flow sub-channels between the fuel rods;

at least one of the spacers being formed of a multiplicity of sub-regions each larger than a respective the grid cell; and

the flow guiding devices being configured and distributed in the spacer to generate a transverse flow distribution in a flow above each the sub-region causing an exchange of cooling water substantially exclusively between flow sub-channels lying within the respective the sub-region.

In other words, the objects are achieved according to the invention by a fuel assembly for a pressurized water nuclear reactor that contains a multiplicity of fuel rods guided in a multiplicity of axially separated spacers. Each of the spacers are constructed from intersecting grid bars that respectively form a grid having a multiplicity of grid cells. The cells are arranged in a grid patters in rows and columns. The grid bars includes flow guides that impose a transverse flow component, oriented parallel to the spacer plane, on the cooling water respectively flowing axially in flow sub-channels between the fuel rods. At least one spacer is constructed from a multiplicity of sub-regions that are each larger than a grid cell, and the flow guiding means are configured and distributed in the spacer so to generate a transverse flow distribution in the flow through each sub-region which causes exchange of cooling water at least almost exclusively between flow sub-channels lying inside the sub-region. In other words: at least in a local subsidiary region lying inside the sub-region and spanning the boundary between two neighboring flow sub-channels, a directed transverse flow is formed over the sub-region which is restricted to the sub-region and does not continue into neighboring sub-regions, or does so only to a negligible extent. At the edge of the sub-region, the velocity component vₙ of the coolant perpendicular to the edge is thus equal to zero.

The fretting resistance is significantly improved by this measure in spite of the critical heat flux being high as before.

The invention is based on the discovery that although a spacer provided with only two deflector elements (split vanes) at each intersection point, as represented for example in FIGS. 15 and 16, leads to significantly better transverse mixing of the coolant over the cross section of the fuel assembly compared with tetraptera (FIG. 14) or compared with the double-walled spacer known from U.S. Pat. No. 4,726,926 and EP 0 237 064 A2 (FIG. 17), so that fuel assemblies constructed using them have a significantly greater critical heat flux. Nevertheless, the transverse flows created in a diagonal direction in the flow through the known spacer provided with split vanes, which extend over the entire cross-sectional area of the fuel assembly, are mechanically disadvantageous since they necessarily lead to resultant forces or torques on the fuel assembly. These forces or torques can lead to self-induced oscillations which may be concomitant with an increased risk of fretting damage.

The invention is now based on the idea that in order to improve the critical heat flux, it is not absolutely necessary to generate a transverse exchange of the coolant over virtually the entire cross-sectional area of the fuel assembly. Rather, it is sufficient for a pronounced transverse exchange of the coolant to take place only between a group of neighboring flow sub-channels of a sub-region.

In a preferred configuration of the invention, the forces or torques exerted by such a local inhomogeneity on the fuel rod sub-bundle passing through the sub-region are at least approximately compensated for overall with respect to the entire fuel assembly cross section in that at least the multiplicity of sub-regions is respectively assigned at least one sub-region disjoint from it, so that the forces and/or torques respectively due to the transverse flow in the sub-region and in the disjoint sub-region assigned to it, or in the disjoint sub-regions assigned to it, at least approximately compensate for each other.

In another preferred configuration of the invention, the sub-region and at least one disjoint sub-region assigned to it are constructed mutually mirror-symmetrically. In a way which is simple in terms of design, the mirror symmetry can achieve at least approximate magnitude equality and opposite directionality of the torques respectively due to the transverse flows in these sub-regions. Owing to the mirror symmetry, furthermore, the forces respectively created in the sub-regions can also compensate for each other.

Preferably, the sub-regions assigned to one another adjoin one another. In this way, the resulting forces and/or torques are compensated for directly at the boundaries of the sub-regions.

In a particularly preferred configuration of the invention, the flow guiding means inside a sub-region are configured so that the transverse flows generated inside this sub-region exert only a torque on it.

Other features which are considered as characteristic for the invention are set forth in the appended claims.

Although the invention is illustrated and described herein as embodied in a fuel assembly for a pressurized water nuclear reactor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows an embodiment of a fuel assembly according to the invention in a partial section above a spacer in a schematic outline representation;

FIGS. 2-5 respectively show a possible distribution of the transverse flow components in a fuel assembly according to the invention above a spacer in likewise schematic outline representations;

FIGS. 6 and 7 show further embodiments in which the spacers comprise a double-walled bar surface with deflector vanes additionally fitted;

FIG. 8 shows an exemplary embodiment in which the fuel assembly comprises a vaneless spacer which is constructed from double-walled bar plates;

FIG. 9 shows an exemplary embodiment in which the fuel assembly comprises a single-walled spacer with offset and equally directed deflector vanes;

FIG. 10 shows an exemplary embodiment with a sub-region whose boundaries extend obliquely to the grid bars;

FIG. 11 shows a detail of a fuel assembly according to the invention in an edge region;

FIG. 12 shows an 18×18 fuel assembly to explain the procedure for practical implementation of the invention,

FIG. 13 is a perspective view of a fuel assembly of a pressurized water nuclear reactor according to the prior art,

FIGS. 14-17 respectively show a fuel assembly in a schematic plan view of a spacer as it is known from the prior art.

### DESCRIPTION OF THE PREFERRED EMBODIMENTS

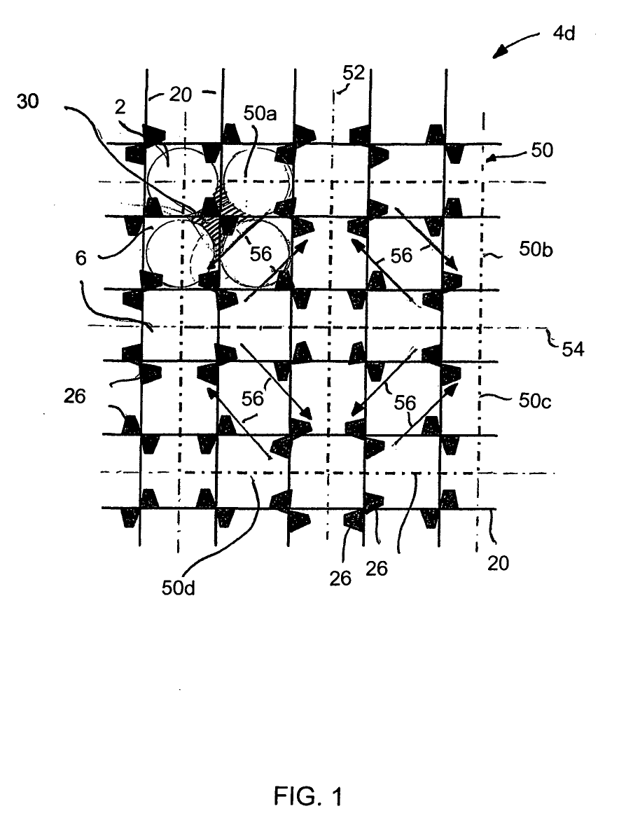

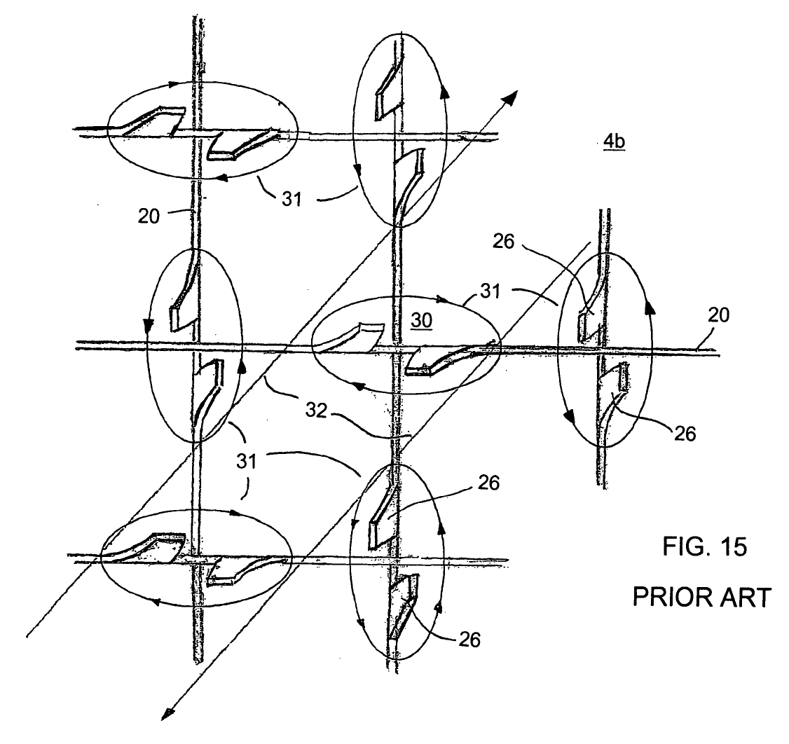

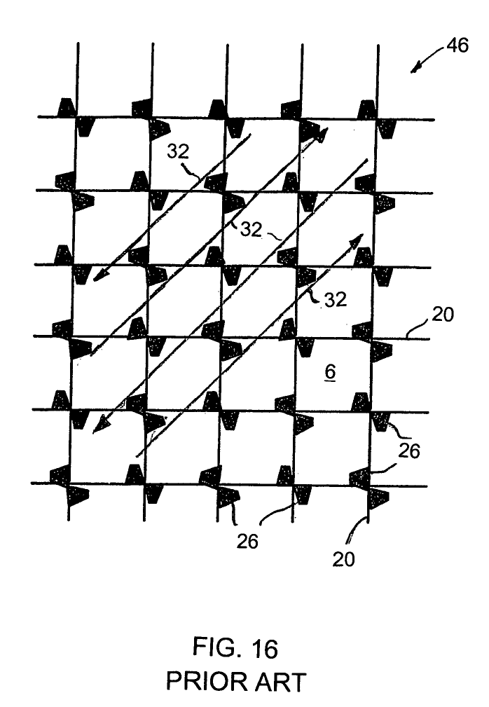

Referring now to the figures of the drawing in detail and first, particularly, to FIG. 1 thereof, there is shown a fuel assembly according to the invention for a pressurized water nuclear reactor PWR. The assembly comprises a spacer 4d whose grid bars 20 are provided downstream with pair-wise arranged deflector elements 26 at the intersection points. These are so-called “split vanes” in the exemplary embodiment, which are of the same type as the deflector elements represented in FIGS. 15 and 16, although according to the invention they are distributed in a different arrangement at the intersection points.

The spacer 4d is constructed from a multiplicity of rectangular, square in the example, disjoint sub-regions 50 which are each larger than an individual grid cell 6. In the exemplary embodiment, each sub-region 50 comprises a full central grid cell 6, respectively four neighboring half grid cells 6 and four quadrants of the diagonally adjacent grid cells 6. The total area of each sub-region 50 therefore corresponds to the area of four grid cells 6. Since the corners of the sub-regions 50 respectively lie in the middle of a grid cell 6, each sub-region 50 covers four full flow sub-channels 30. This is illustrated by shading for a flow sub-channel 30 surrounded by four fuel rods 2. Four full sub-regions 50a-d are indicated in the figure. The flow guiding elements 26 lying inside a sub-region 50a-d are arranged mirror-symmetrically to the deflector elements of the sub-region 50a-d respectively neighboring at a common interface. Sub-region 50b is thus derived from the sub-region 50a by reflection through a mirror plane 52 extending perpendicularly to the plane of the drawing. Correspondingly, sub-region 50c is mirror-symmetric to the sub-region 50b with respect to a mirror plane 54. Sub-region 50d is derived from the sub-region 50c by reflection through the mirror plane 52, and sub-regions 50a and 50d are mutually mirror-symmetric with respect to the mirror plane 54. The sub-regions neighboring the sub-regions 50a-d, which are only partially reproduced in the figure, are constructed in the same way. The sub-region 50a is mapped onto itself by the fourfold reflection through mirror planes respectively orthogonal to one another and intersecting on a straight line.

The effect of this design layout is now that in each of the sub-regions 50a-d, it is only possible to form transverse flows 56 which are locally limited to the respective sub-region 50a-d and do not extend beyond its boundaries, but instead they encounter at these boundaries transverse flows of the neighboring sub-region 50a-d which have a different direction. Locally limited transverse following in the context of the invention means that the normal component vₙ of the horizontal flow velocity at the edge of each sub-region 50a-d is at least approximately equal to zero: vₙ=0.

In each of the sub-regions 50a-d in the exemplary embodiment, locally directed transverse flows are created which produce transverse exchange of cooling water between neighboring flow sub-channels 30 that lie inside a sub-region 50a-d. They respectively intersect with the local transverse flows of the neighboring sub-region, however, so that they cannot be combined to form overall flow patterns. The mirror-symmetric arrangement of the four sub-regions 50a-d arranged around an intersection point thus effectively prevents the creation of large-area transverse flows, i.e. ones extending over the entire cross section of the fuel assembly.

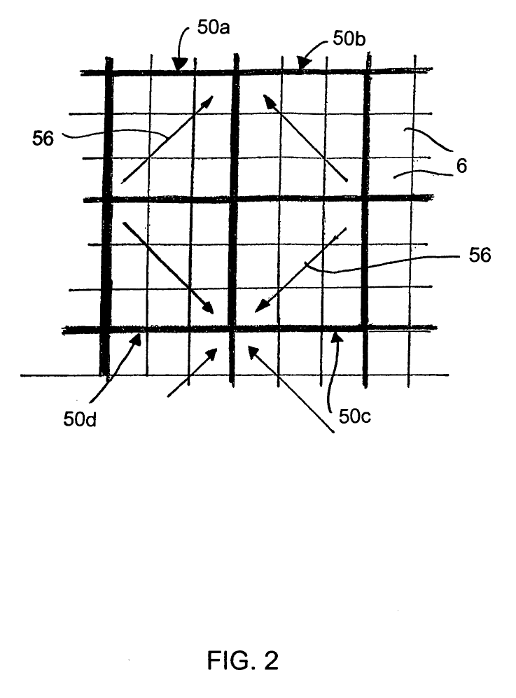

In the exemplary embodiment according to FIG. 2, sub-regions 50a-d are provided which are each constructed from nine full grid cells 6. In these sub-regions 50a-d, flow guiding means form transverse flows 56 which, as represented in the exemplary embodiment, extend diagonally over the entire respective sub-region 50a to d. On each sub-region 50a-d, only a force but no torque is exerted by the transverse flow 56 respectively formed in it, with force equilibrium being obtained overall as regarded over the entire cross section of the fuel assembly.

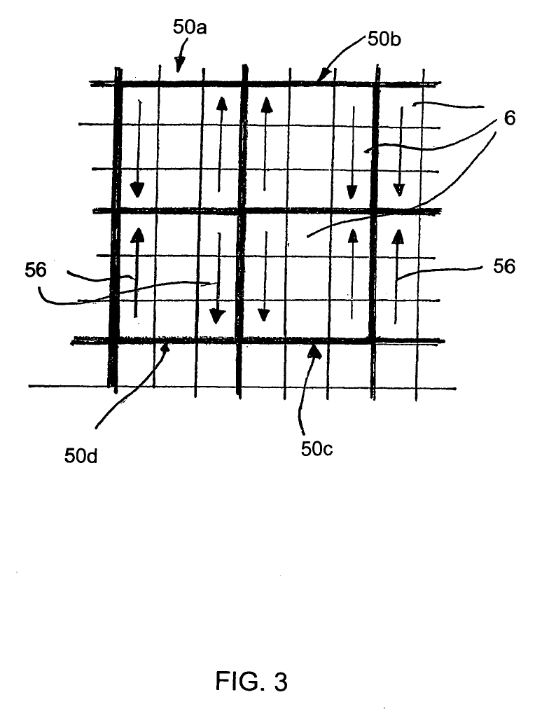

The flow guiding means are not explicitly represented in this and the following FIGS. 3-5, since these figures serve only to explain flow patterns that are possible in principle, and the flow guiding means suitable for this may be produced in a multiplicity of possible design configurations.

In these exemplary embodiments as well, the sub-regions 50a to d are constructed mirror-symmetrically to one another so that they are derived from one another by reflection through a mirror plane lying in the respective interface. It can furthermore be seen in the example of FIG. 3 that both the overall torque acting on the four mutually adjacent sub-regions 50a to d and the forces acting on them compensate for one another.

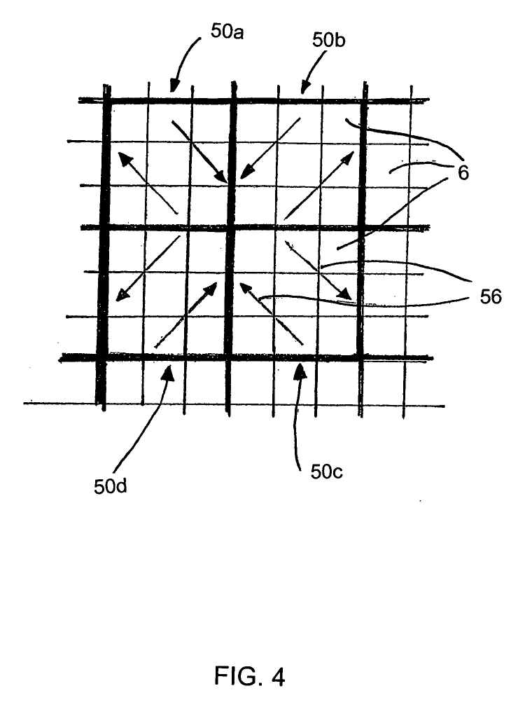

In the exemplary embodiments according to FIGS. 3 and 4, transverse flows 56 opposing one another pair-wise are generated by flow guiding means in each of the sub-regions 50a-d, these extending either parallel to the grid columns in the example of FIG. 3 or, as in FIG. 4, diagonally thereto similarly as the exemplary embodiment according to FIG. 1.

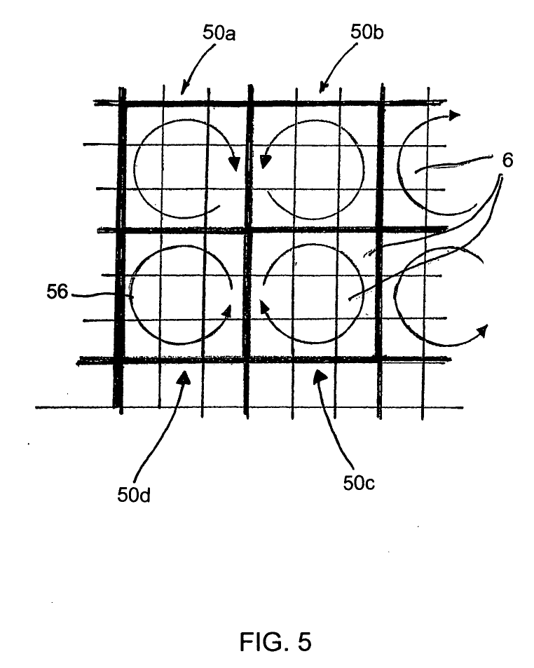

FIG. 5 shows a situation in which only a circular flow 56 is generated in each sub-region 50a-d, the rotation direction of which is opposite to the rotation direction of the circular flow 56 generated in neighboring sub-regions 50a-d.

In all the exemplary embodiments according to FIGS. 2-5, transverse exchange of the cooling water takes place only between flow sub-channels or between the sub-segments of different flow sub-channels which lie inside a sub-region 50a-d.

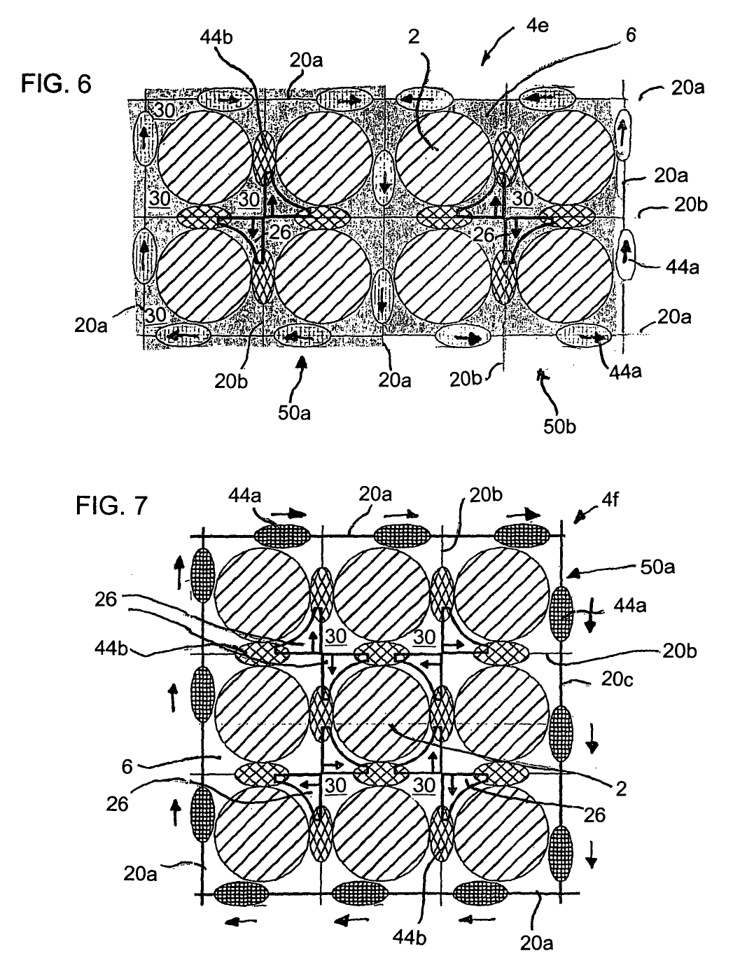

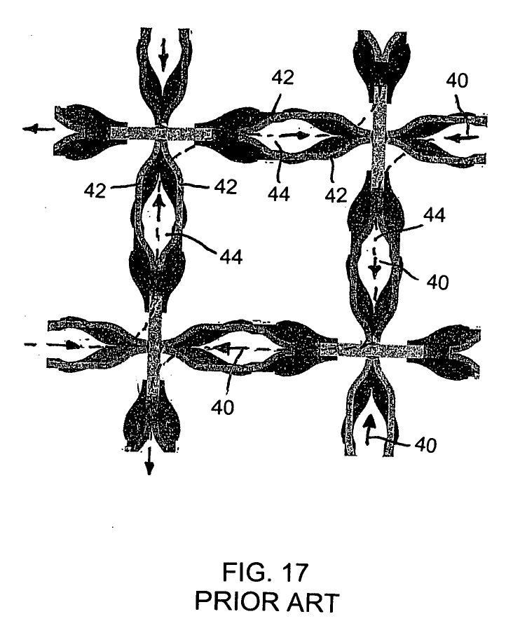

In the exemplary embodiment according to FIG. 6, a spacer 4e is provided which is constructed from first and second double-walled grid bars 20a, b that comprise first and second flow channels 44a and b through corresponding profiles schematically indicated in the figure. The first flow channels 44a extend obliquely to the vertical, i.e. obliquely to the fuel assembly axis. They act as flow guiding means which impose a velocity component transverse to the vertical on the cooling water, as is also the case in the spacer known from U.S. Pat. No. 4,726,926 EP 0 237 064 A2 (FIG. 17). The second grid bars 26b are provided with the second flow channels 44b denoted by cross hatching, the mid-axes of which extend parallel to the vertical.

A sub-region 50a, b is respectively formed by four grid cells 6 in this exemplary embodiment, the first flow channels 44a respectively being arranged at the edge of each sub-region 50a, b. The sub-regions 50a, b are likewise derived from one another by reflection through a mirror plane defined by the interface between these two sub-regions 50a, b. The obliquely extending first flow channels 44a generate a circulating flow in each sub-region 50a, b, although they are directed oppositely to each other. This circular flow travels clockwise in the sub-region 50a, and counterclockwise in the sub-region 50b. In the middle of each sub-region 50a, b, deflector elements 26 are arranged which additionally generate a circular flow in the central flow sub-channel 30, which is directed oppositely to the flows circulating outside so that the torque respectively generated on the entire sub-region 50a, b is correspondingly reduced and good cooling of the zones of the fuel rods neighboring the central flow sub-channels 30 is ensured.

The circulating flow respectively generated at the outer circumference of the sub-regions 50a, b generates better mixing between flow sub-channels 30 which lie at the edge of the respective sub-region. This, however, is restricted to the transverse exchange between the sub-segments of different flow sub-channels 30 which lie inside the sub-region 50a, b. In this exemplary embodiment as well, the sub-regions 50a, b are constructed according to the same reflection rules as those explained with reference to FIGS. 1 to 5.

The exemplary embodiment according to FIG. 7, illustrates a sub-region 50a of a spacer 4f which contains nine grid cells 6 instead of four grid cells 6. In this case as well, the grid bars 20a, b of the spacer 4f are double-walled so that first and second flow channels 44a, b respectively extending obliquely and parallel to the vertical are formed by corresponding profiles in the bar plates, so that an externally circulating flow is generated around each sub-region, only one of which is represented in the figure. At the inner-lying intersection points, deflector elements 26 are arranged which generate a circular flow in the inner-lying flow sub-channels 30 and thereby lead to improved cooling of the inner-lying fuel rod 2 and the zones of the outer-lying fuel rods 2 neighboring it.

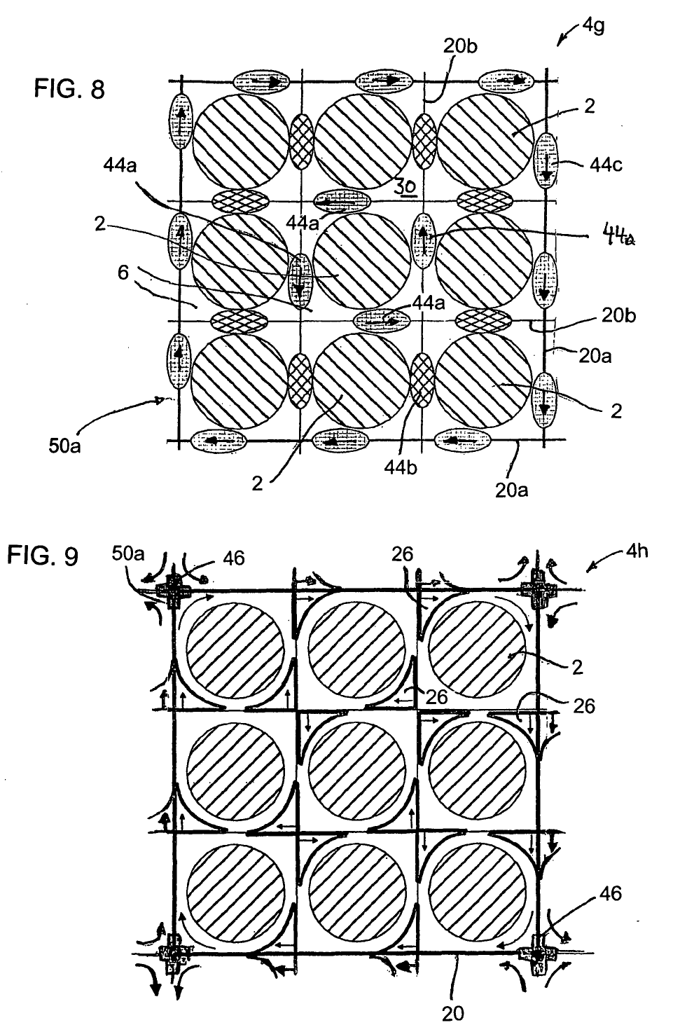

Instead of the vane-shaped deflector elements respectively provided at the inner-lying intersection points in the exemplary embodiments according to FIGS. 6 and 7, the central grid cell 6 in a spacer 4g according to FIG. 8 may also be provided with obliquely directed first cooling channels 44a which, around the central fuel rod 2, generate a circulating flow which is directed oppositely to the circulating flow generated outside. In this exemplary embodiment, the second grid bar 20b contains flow channels both of the type 44a (inclined to the vertical) and of the type 44b (parallel to the vertical).

Such a circulating flow around the sub-region can also be generated by single-walled grid bars and deflector elements 26 formed on them, as illustrated for a spacer 4h in FIG. 9. In order to cause respectively opposing deflection at the corners in all four abutting sub-regions, the grid bars are extended at the intersection points. This is schematically indicated in the FIG. by crosses 46 with a greater line thickness. This does not involve a wall thickness increase of the bars 20, however, but merely an increase of their bar height limited to the corners.

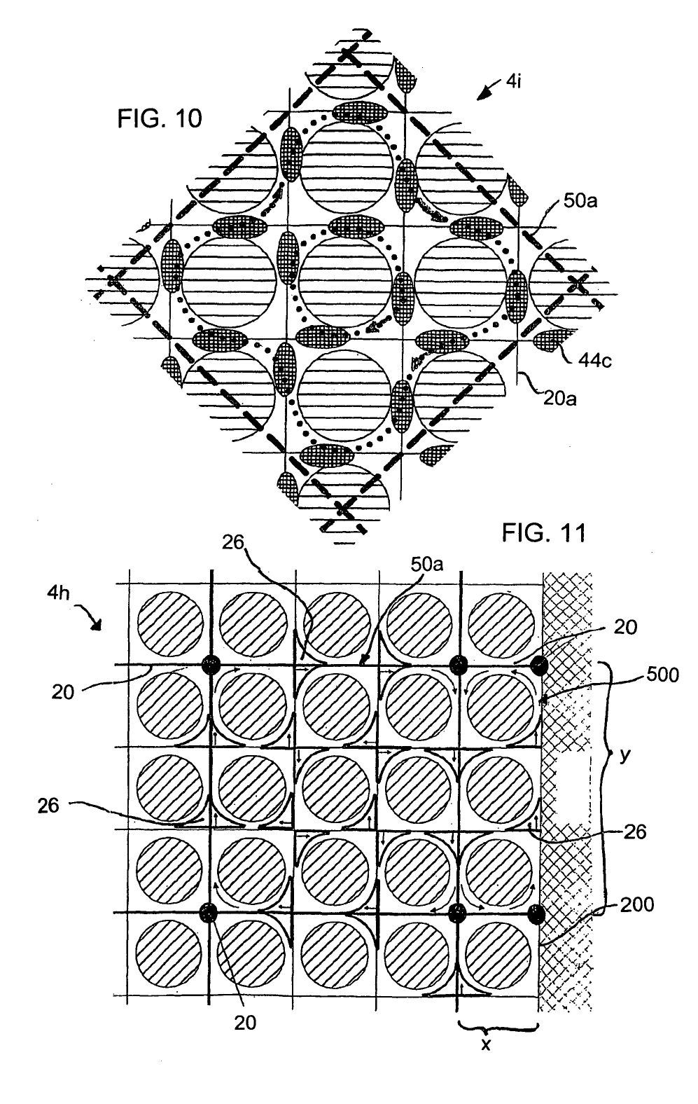

The exemplary embodiment according to FIG. 10 illustrates a sub-region 50a of a spacer 4i whose boundaries extend parallel to the grid diagonals. The spacer 4i is constructed from first double-walled first grid bars 20a, each of which is provided with first flow channels 44a extending obliquely to the vertical. The neighboring sub-regions are constructed according to the reflection principles explained above, i.e. they are respectively mirror-symmetric with respect to mirror planes that are perpendicular to the plane of the drawing and also form the interface with the respectively neighboring sub-region. In this exemplary embodiment as well, as in the exemplary embodiments according to FIGS. 6-9, only a torque is generated on each sub-region 50a by the inner and outer circulating flow generated in this case.

For simplicity, the previous examples have been based on a fuel assembly which can be constructed by appropriate reflection rules starting from one sub-region. This is not readily possible in a real fuel assembly, however, since the strict symmetry required for this is broken in a narrow configuration at the lateral edge regions of the fuel assembly and in the region of the structure tubes arranged in the fuel assembly. FIG. 11 now shows a situation which can occur at the edge region of a fuel assembly. The edge region of a spacer 4h as already explained in FIG. 9 is represented. It can be seen in the figure that the reflection rules explained with reference to the previous figures can no longer be applied in a strict sense to neighboring sub-regions. The sub-region 50a cannot be continued toward the edge bar 200 by reflection. In these edge regions or in regions of broken symmetry, further sub-regions are now established which differ in their size and in their structure from other sub-regions. In the exemplary embodiment, a sub-region 500 comprising three grid cells 6 (denoted in the figure by curled brackets x, y) is established at the edge, in which deflector elements 26 are arranged so as to create a circulating flow in this sub-region. On the opposite edge bar there is now a complementary sub-region which is constructed mirror-symmetrically thereto, so that the torques generated in the sub-region 500 and in the complementary disjoint sub-region assigned to it compensate for each other, and furthermore no torque can be created in relation to the full cross section of the fuel assembly. In this case as well, the grid bars 20 are heightened in the corners of the sub-regions (illustrated by black circles).

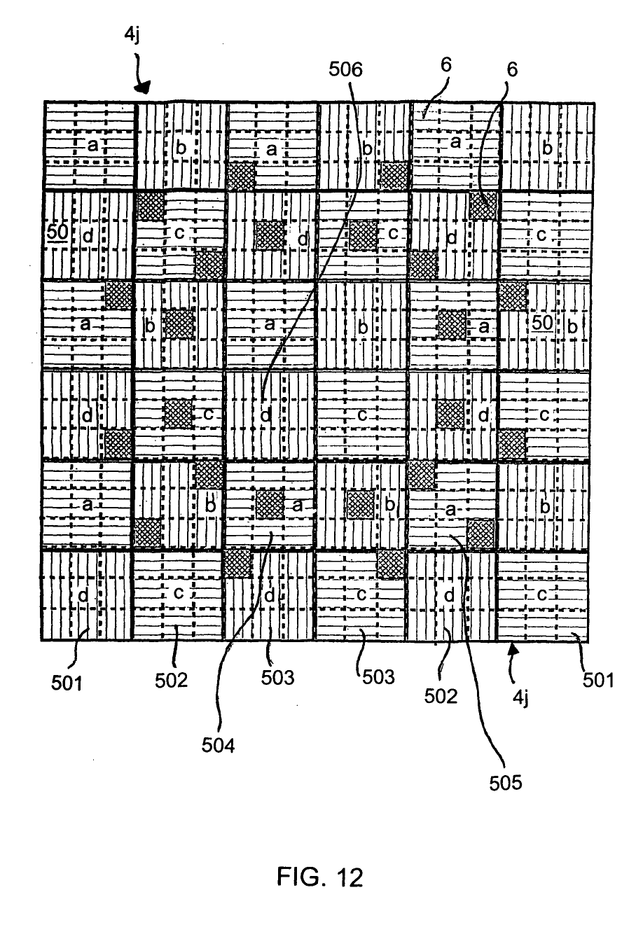

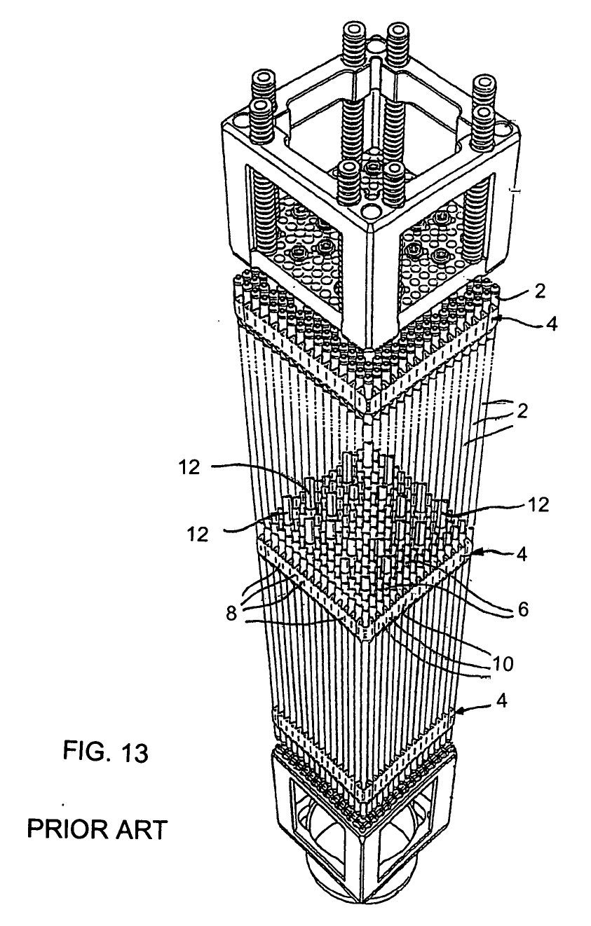

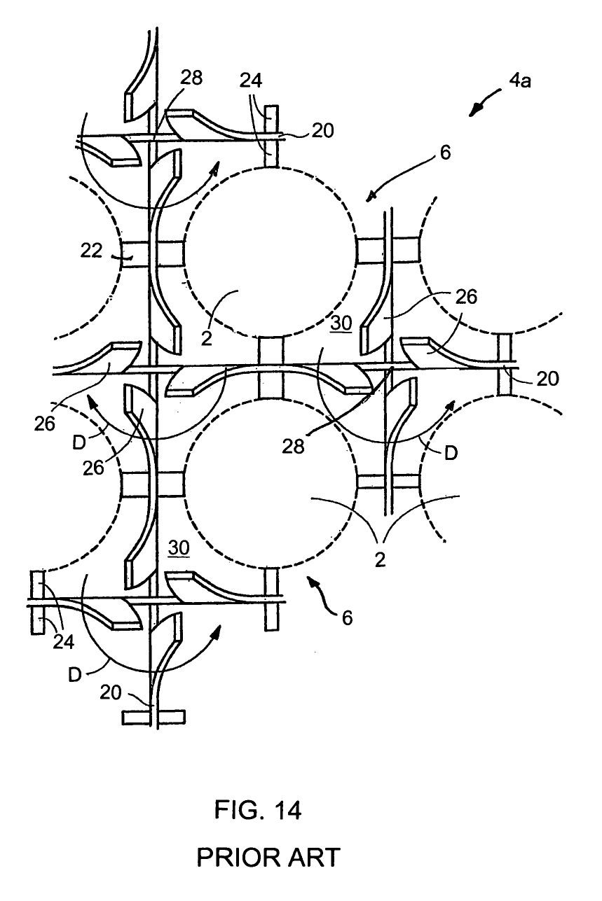

FIG. 12 now shows the situation in a fuel assembly having a spacer 4j with 18×18 grid cells 6, of which twenty-four grid cells 6 highlighted by cross-hatching have control rod guide tubes passing through them (control rod guide tubes and fuel rods are not represented for the sake of clarity). In this exemplary embodiment, the spacer 4j is decomposed into thirty-six disjoint sub-regions 50 which each contain nine grid bars 6. It can now be seen in the figure that the sub-regions 50 can be allocated to six different classes 501 to 506, which differ from one another either by their position at the edge of the spacer 4j or by the arrangement/number of the control rod guide tubes inside them, so that they cannot be converted into one another by reflections. These are four sub-regions of class 501 at the corners of the spacer 4j, eight sub-regions of class 502 neighboring them, which also lie at the corners of the spacer 4j, eight sub-regions of class 503 which are provided with control rod guide tubes in one of their corners, and eight inner-lying sub-regions of class 504, the central grid cell 6 of which is provided with a control rod guide tube. Four sub-regions of class 505 are respectively crossed by control rod guide tubes at a diagonally opposite grid cell 6, and four inner-lying sub-regions of class 506 are not crossed by control rod guide tubes.

The four inner-lying sub-regions of class 506 can now be constructed mirror-symmetrically to one another, as explained with reference to FIGS. 1 to 10 and indicated by the letters a-d, sub-region 506b being derived by reflection from 506a, 506c being mirror-symmetric to 506b and 506d being mirror-symmetric to 506c, so that 506a is again mirror-symmetric to 506d. In the same way, the other sub-regions are constructed mirror-symmetrically to one another. The four sub-regions of class 501 at the corners of the spacer 4j constructed mirror-symmetrically to one another in the same way, as likewise indicated by the letters a-d in the figure.

The letters a-d denote one type in each class 501-506. Sub-regions of different classes 501-506 but of the same type a-d are substantially equivalent in terms of the design layout and the arrangement of the flow deflecting means arranged in them, i.e. the intrinsic symmetry.

The design principle specified for the sub-regions 506a to d is now maintained for the entire spacer 4j so that, for example, the type b sub-region of class 506 and the type a sub-region of class 504 arranged to the right of it substantially correspond in their structure. This design principle is continued over the entire spacer 4j, so that overall transverse flows cannot be created in this exemplary embodiment either. It furthermore ensures that for each class 501-506, there are four or eight sub-regions constructed mirror symmetrically to one another according to the aforementioned design principles, so that all torques and forces vanish in relation to the entire cross-sectional area of the fuel assembly.

For spacers whose number of columns and rows is a prime number, different types of sub-regions that vary in size must be introduced according to FIG. 11.

We Claim:

1. A fuel assembly for a pressurized water nuclear reactor, comprising:
a multiplicity of fuel rods;
a multiplicity of axially separated spacers holding said fuel rods, said spacers being constructed of mutually intersecting grid bars forming a grid with a multiplicity of grid cells arranged along rows and columns;
said grid bars including flow guiding devices for imposing a transverse flow component, oriented parallel to a spacer plane, on cooling water respectively flowing axially in flow sub-channels between said fuel rods;
at least one of said spacers being formed of a multiplicity of sub-regions each larger than a respective said grid cell; and
said flow guiding devices being configured and distributed in said spacer to generate a transverse flow distribution in a flow above each said sub-region causing an exchange of cooling water substantially exclusively between flow sub-channels lying within the respective said sub-region.

2. The fuel assembly according to claim 1, wherein at least one of said multiplicity of sub-regions is assigned at least one disjoint sub-region such that forces and/or torques caused by the transverse flow in the sub-region and in the disjoint sub-region assigned to the respective said sub-region at least approximately compensate for each other.

3. The fuel assembly according to claim 1, wherein said sub-regions are assigned at least one disjoint sub-region each, and said disjoint sub-regions are configured such that forces and/or torques caused by the transverse flow in the respective said sub-region and in the respective said disjoint sub-region assigned thereto compensate each other at least approximately.

4. The fuel assembly according to claim 2, wherein said sub-region and said at least one disjoint sub-region assigned thereto are mutually mirror-symmetric.

5. The fuel assembly according to claim 4, wherein the mirror-symmetric arrangement defines a plane of mirror symmetry extending perpendicularly to a plane of said spacer and substantially parallel to a respective said grid bar.

6. The fuel assembly according to claim 2, wherein said sub-regions assigned to one another adjoin one another.

7. The fuel assembly according to claim 2, wherein said sub-regions assigned to one another adjoin one another.

8. The fuel assembly according to claim 1, wherein said flow guiding devices inside a respective said sub-region are configured such that the transverse flows generated inside said sub-region exert substantially only a torque thereon.
